(19) United States
(12) Patent Application Publication
(10) Pub. No.: US 2010/0262846 A1
(43) Pub. Date: Oct. 14, 2010

(54) INFORMATION PROCESSING DEVICE, INFORMATION PROCESSING METHOD, AND INFORMATION PROCESSING SYSTEM

(75) Inventor: Kazuhiro Sato, Tokyo (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/755,022

(22) Filed: Apr. 6, 2010

(30) Foreign Application Priority Data
Apr. 14, 2009 (JP) 2009-097662

(51) Int. Cl. G06F 1/26; G06F 1/00; H04L 9/32

(52) U.S. Cl. 713/300; 713/600; 726/2

(57) ABSTRACT

An information processing device includes: a setting means for setting a standby time independently from another information processing device as an authentication target in a case where an authentication request is made from an authentication request-side device; and a transmission means for waiting for the standby time set by the setting means and transmitting unique identification information to the authentication request-side device.

### BACKGROUND OF THE INVENTION

1. Field of the Invention

The present invention relates to an information processing device, an information processing method, and an information processing system, and more particularly, to an information processing device, an information processing method, and an information processing system that are capable of authenticating a desired device out of a plurality of devices.

2. Description of the Related Art

Recently, systems that transmit power in a non-contacting manner are researched and developed (for example, see JP-A-2008-295191). Hereinafter, such systems will be referred to as non-contacting power transmission systems.

In non-contacting power transmission systems, as a device authentication technique used for a power transmission-side device to authenticate a power reception-side device, for example, as disclosed in JP-A-2008-295191, a technique for performing a series of processes described below is generally used.

In other words, according to general device authentication techniques including JP-A-2008-295191, it is premised that the number of power reception-side devices for one power transmission-side device is one. In addition, according to general device authentication techniques, identification information (a unique production serial number or the like) of the power reception-side device is stored in the power transmission-side device in advance.

On the premise described above, according to the general device authentication techniques, a request process, a response process, and an authentication process as described below are sequentially performed. The request process is a process of the power transmission-side device for requesting the power reception-side device to transmit identification information. In addition, the response process is a process of the power reception-side device for transmitting the identification information as a response to the request. The authentication process is a process of the power transmission-side device for authenticating the power reception-side device by comparing the identification information transmitted from the power reception-side device with the identification information stored in the power transmission-side device and checking coincidence of the identification information.

### SUMMARY OF THE INVENTION

There is a request for authenticating a desired device out of a plurality of devices. However, according to general device authentication techniques including JP-A-2008-295191, it is difficult to sufficiently respond to such a request.

In other words, in a case where a general device authentication technique is directly applied to such a request, the response process for the request process is performed by each of a plurality of the power reception-side devices. Accordingly, the identification information is simultaneously transmitted to the power transmission-side device from the plurality of the power reception-side devices so as to cause interference with one another. As a result, it is difficult for the power transmission-side device to perform the authentication process.

There is a need for authenticating a desired device out of a plurality of devices.

According to an embodiment of the present invention, there is provided an information processing device including: a setting means for setting a standby time independently from another information processing device as an authentication target in a case where an authentication request is made from an authentication request-side device; and a transmission unit for waiting for the standby time set by the setting means and transmitting unique identification information to the authentication request-side device.

The setting means may generate a random number in a case where the authentication request is made and sets the standby time in correspondence with the random number.

The authentication request may be an identification signal that is set by the authentication request-side device in advance.

The transmission means may be configured to stop the transmitting of the unique identification information when recognizing transmission from another information processing device as the authentication target.

A power reception means for receiving power transmitted from a power transmission device may be further included, and the authentication request-side device may be configured by the power transmission device that transmits the power by using a magnetic resonance-type power transmission technique.

The power transmission device may start the transmitting of the power before the authentication request.

According to another embodiment of the present invention, there is provided an information processing method including the step of: setting a standby time independently from another information processing device as an authentication target in a case where an authentication request is made from an authentication request-side device, waiting for the set standby time, and transmitting unique identification information to the authentication request-side device by using the information processing device that becomes an authentication target of the authentication request-side device.

According to another embodiment of the present invention, there is provided an information processing system including: an authentication request-side device; and one or more information processing devices that become authentication targets. The authentication request-side device makes an authentication request for each of the one or more information processing devices, each of the one or more information processing devices sets a standby time independently from the other information processing devices as authentication targets, waits for the set standby time, and transmits unique identification information to the authentication request-side device in a case where the authentication request is made, and the authentication request-side device performs authentication of each of the one or more information processing devices by receiving the unique identification information transmitted from each of the one or more information processing devices.

According to another embodiment of the present invention, there is provided an information processing device including: a transmission means for transmitting identification information that is the same as that of another information processing device as an authentication target to an authentication request-side device in a case where an authentication request is made from the authentication request-side device.

According to another embodiment of the present invention, there is provided an information processing method including the step of: transmitting identification information that is the same as that of another information processing device as an authentication target to an authentication request-side device by using an information processing device that becomes an authentication target of the authentication request-side device in a case where an authentication request is made from the authentication request-side device.

According to another embodiment of the present invention, there is provided an information processing system including: an authentication request-side device; and one or more information processing devices that become authentication targets. The authentication request-side device makes an authentication request for each of the one or more information processing devices, each of the one or more information processing devices transmits identification information that is the same as those of the other information processing devices as authentication targets to the authentication request-side device in a case where the authentication request is made, and the authentication request-side device performs authentication by receiving the identification information transmitted from at least one of the one or more information processing devices.

According to an embodiment of the present invention, the following processes are performed by the authentication request-side device and one or more information processing devices that become authentication targets. The authentication request-side device makes an authentication request for each of the one or more information processing devices, and each of the one or more information processing devices sets a standby time independently from the other information processing devices as authentication targets, waits for the set standby time, and transmits unique identification information to the authentication request-side device in a case where the authentication request is made. The authentication request-side device performs authentication of each of the one or more information processing devices by receiving the unique identification information transmitted from each of the one or more information processing devices.

According to another embodiment of the present invention, the following processes are performed by the authentication request-side device and one or more information processing devices that become authentication targets. The authentication request-side device makes an authentication request for each of the one or more information processing devices, and each of the one or more information processing devices transmits identification information that is the same as those of the other information processing devices as authentication targets to the authentication request-side device in a case where the authentication request is made. The authentication request-side device performs authentication by receiving the identification information transmitted from at least one of the one or more information processing devices.

According to an embodiment of the present invention, a desired device out of a plurality of devices can be authenticated.

### BRIEF DESCRIPTION OF THE DRAWINGS

FIG. 1 is a diagram showing a configuration example of a power transmission system as an information processing system according to an embodiment of the present invention.

FIG. 2 is a diagram representing a configuration example of a power transmission device of the power transmission system shown in FIG. 1.

FIG. 3 is a diagram representing a configuration example of a power reception device of the power transmission system shown in FIG. 1.

FIG. 4 is a flowchart illustrating an example of a power transmission-side authentication process.

FIG. 5 is a flowchart illustrating an example of a power reception-side authentication reception process.

FIG. 6 is a flowchart illustrating an example of the relationship of mutual processes of a power transmission device and two power reception devices.

FIG. 7 is a flowchart illustrating an example of the relationship of mutual processes of a power transmission device and two power reception devices.

FIG. 8 is a flowchart illustrating an example of a power transmission-side authentication process.

FIG. 9 is a flowchart illustrating an example of a power reception-side authentication reception process.

FIG. 10 is a block diagram representing a configuration example of the hardware of a computer according to an embodiment of the present invention.

### DETAILED DESCRIPTION OF THE INVENTION

Hereinafter, information processing systems according to embodiments of the present invention will be described with reference to the accompanying drawings. Description will be made in the following order.

### <1. Configuration of Information Processing System>

### [Configuration Example of Power Transmission System]

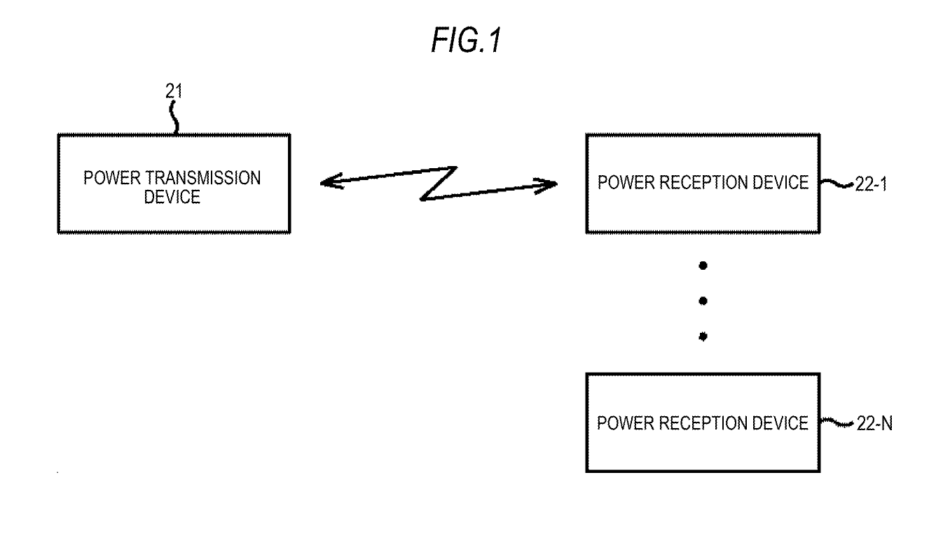

FIG. 1 shows a configuration example of a power transmission system as an information processing system according to an embodiment of the present invention.

The power transmission system of the example shown in FIG. 1 is configured by a power transmission device 21 and power reception devices 22-1 to 22-N (here, N is an integer equal to or greater than one).

Hereinafter, in a case where the power reception devices 22-1 to 22-N do not need to be individually identified, the power reception devices are collectively referred to as power reception devices 22.

When the switching state transits from the OFF state to the ON state, the power transmission device 21 starts to supply power to the power reception devices 22. The power reception devices 22 start to operate by using the power supplied from the power transmission device 21.

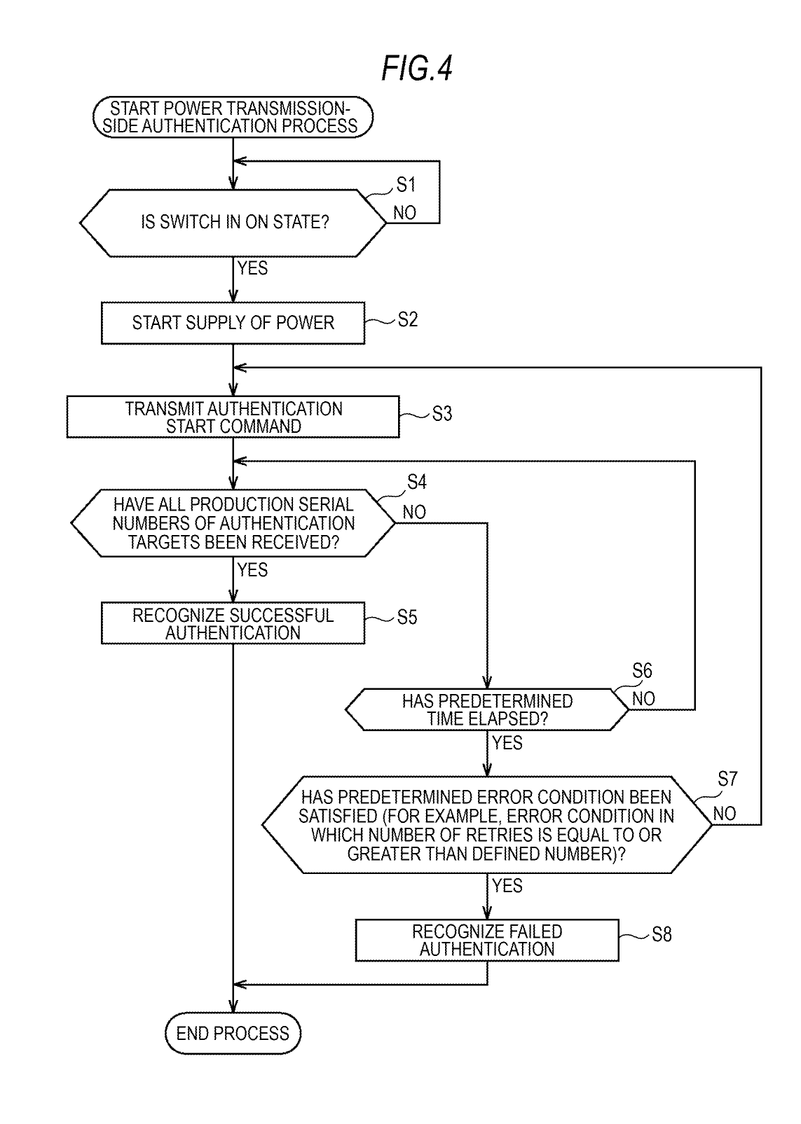

In addition, the power transmission device 21 can authenticate each of the power reception devices 22-1 to 22-N. The authentication process will be described later in detail with reference to FIG. 4 and thereafter.

### [Configuration Example of Power Transmission Device]

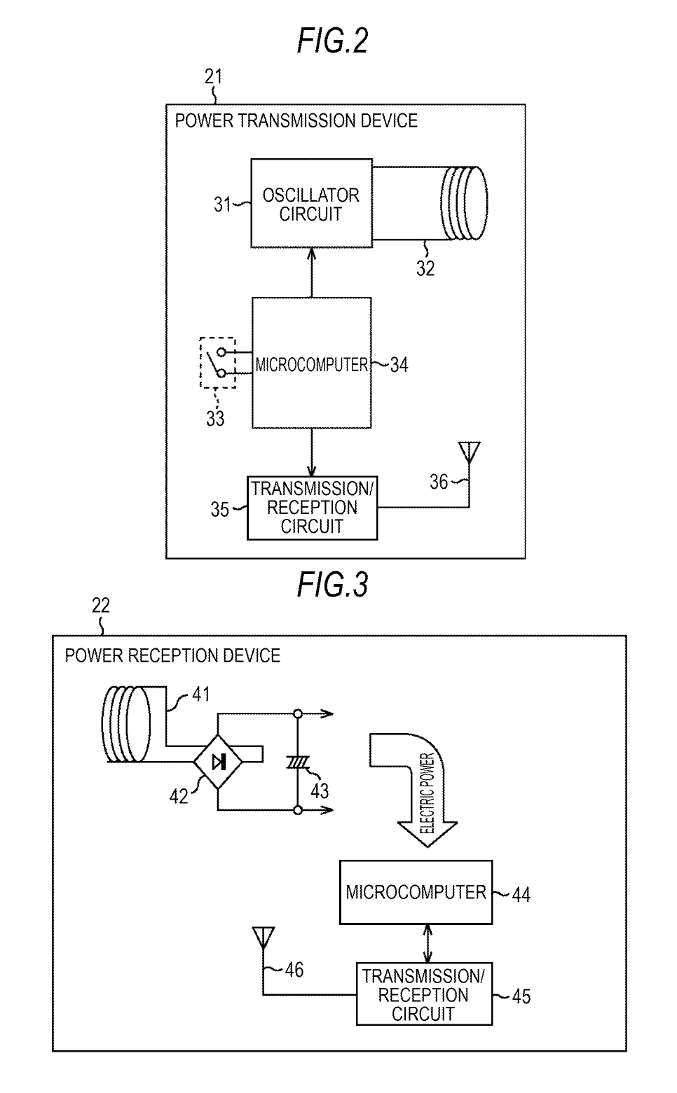

FIG. 2 represents a configuration example of the power transmission device 21 of the power transmission system shown in FIG. 1.

The power transmission device 21 is configured by an oscillator circuit 31, a power transmission coil 32, a switch 33, a microcomputer 34, a transmission/reception circuit 35, and an antenna 36.

The power transmission coil 32 is configured by a coil that is, for example, wound several times in the shape of a loop. The oscillator circuit 31 is connected to the power transmission coil 32. When starting an oscillation operation, the oscillator circuit 31 outputs an alternating current with a predetermined frequency. When the alternating current that is output from the oscillator circuit 31 flows through the power transmission coil 32, an electromagnetic wave is radiated from the power transmission coil 32. Through this electromagnetic wave, power is supplied to the power reception devices 22.

The switch 33 is connected to the microcomputer 34. The switch 33 is shifted between the ON state and the OFF state based on a user's operation.

The microcomputer 34 controls the overall operation of the power transmission device 21. For example, when the switch 31 is in the ON state, the microcomputer 34 starts the oscillation operation of the oscillator circuit 31, and thereby starting supply of power to the power reception devices 22. In addition, for example, the microcomputer 34 transmits or receives various types of information (for example, an authentication start command, a production serial number, an ACK command, or the like to be described later) to or from the power reception devices 22 by controlling the transmission/reception circuit 35. In particular, for example, the microcomputer 34 controls performing of a power transmission-side authentication process represented in FIG. 4 to be described later.

The transmission/reception circuit 35 transmits or receives various types of information (for example, an authentication start command, a production serial number, an ACK command, or the like to be described later) to or from the power reception devices 22 through the antenna 36 under control of the microcomputer 34.

### [Configuration Example of Power Reception Device]

FIG. 3 represents a configuration example of the power reception device 22 of the power transmission system shown in FIG. 1.

The power reception device 22 is configured by a power reception coil 41, a bridge rectifier circuit 42, a smoothing capacitor 43, a microcomputer 44, a transmission/reception circuit 45, and an antenna 46.

The power reception coil 41, for example, is configured by a coil that is wound several times in the shape of a loop and is connected to the bridge rectifier circuit 53. The frequency of the alternating current flowing through the bridge rectifier circuit 53 is relatively high. Thus, a first recovery diode or the like is preferably used in the bridge rectifier circuit 53. To both output-side ends of the bridge rectifier circuit 53, the smoothing capacitor 54 is connected. The smoothing capacitor 54, for example, is configured by an electrolytic capacitor.

Through the power reception coil 41, an alternating current, which is induced by the electromagnetic wave radiated from the power transmission coil 32 of the power transmission circuit 21, flows. Then, full-wave rectification is performed for this alternating current by the bridge rectifier circuit 53. The full-wave rectified current (ripple current) is converted into a direct current by the smoothing capacitor 54 and is supplied to a circuit of a latter stage not shown in the figure.

As described above, in the power transmission system shown in FIG. 1, power is supplied from the power transmission device 21 to the power reception device 22 in a non-contacting manner.

The microcomputer 44 and the transmission/reception circuit 45 operate by using the power supplied from the power transmission device 21 as described above.

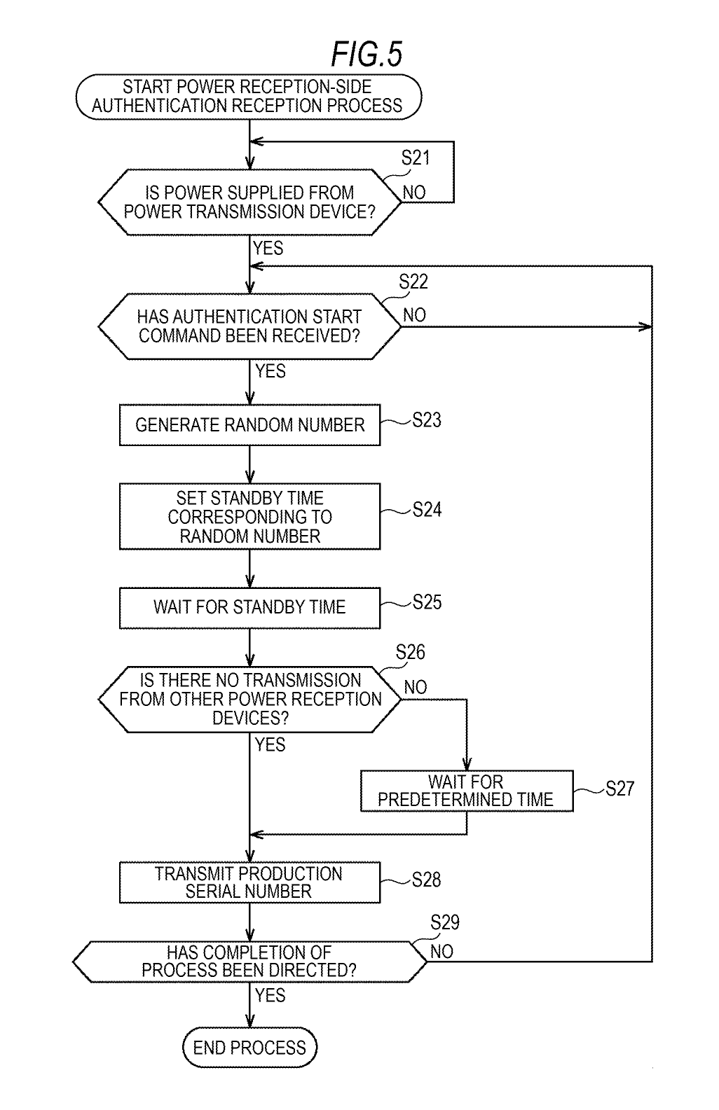

The microcomputer 44 controls the overall operation of the power reception device 22. For example, the microcomputer 44 transmits or receives various types of information (for example, an authentication start command, a production serial number, an ACK command, or the like to be described later) to or from the power transmission device 21 by controlling the transmission/reception circuit 45. In particular, for example, the microcomputer 44 controls performing of a power reception-side authentication reception process represented in FIG. 5 to be described later.

The transmission/reception circuit 45 transmits or receives various types of information (for example, an authentication start command, a production serial number, an ACK command, or the like to be described later) to or from the power reception device 21 through the antenna 46 under control of the microcomputer 44.

### <2. First Example of Authentication Operation of Information Processing System>

Next, of processes performed by the power transmission system shown in FIG. 1, a first example of a series of processes until the power transmission device 21 authenticates the power reception device 22 will be described. Hereinafter, of the series of processes, a process performed on the power transmission device 21 side is referred to as a power transmission-side authentication process, and a process performed on the power reception device 22 side is referred to as a power reception-side authentication reception process.

FIG. 4 is a flowchart illustrating an example of the power transmission-side authentication process.

FIG. 5 is a flowchart illustrating an example of the power reception-side authentication reception process.

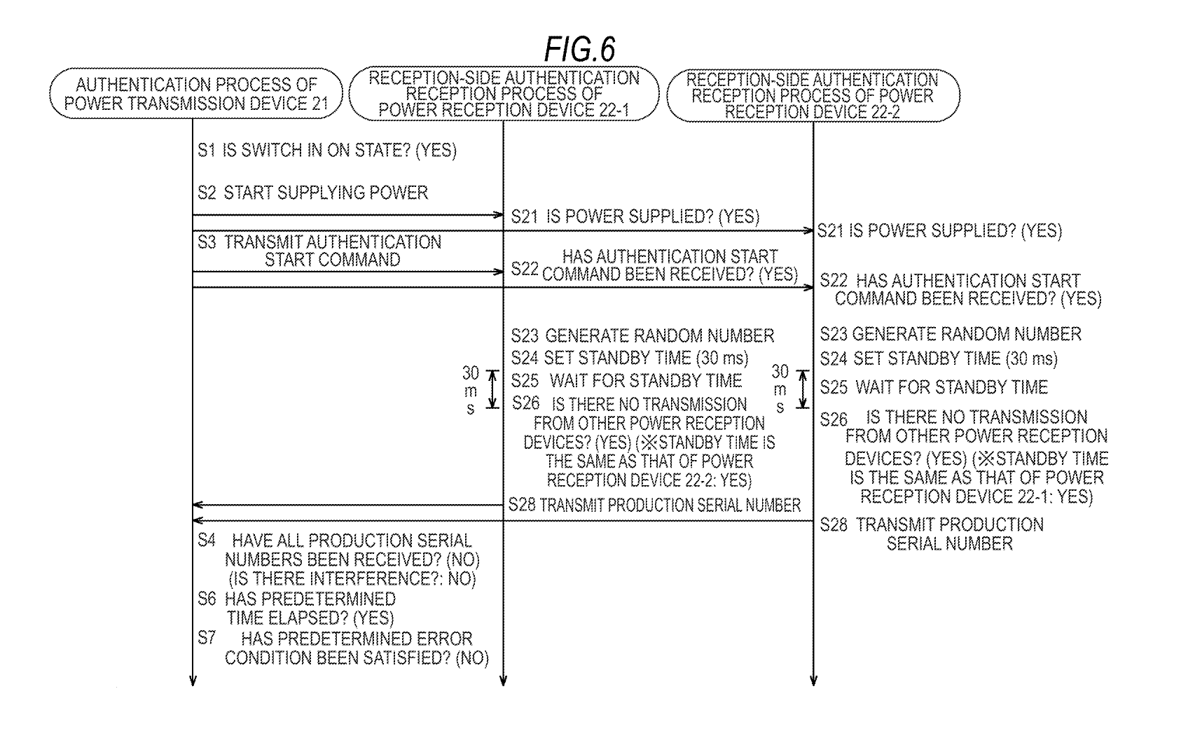

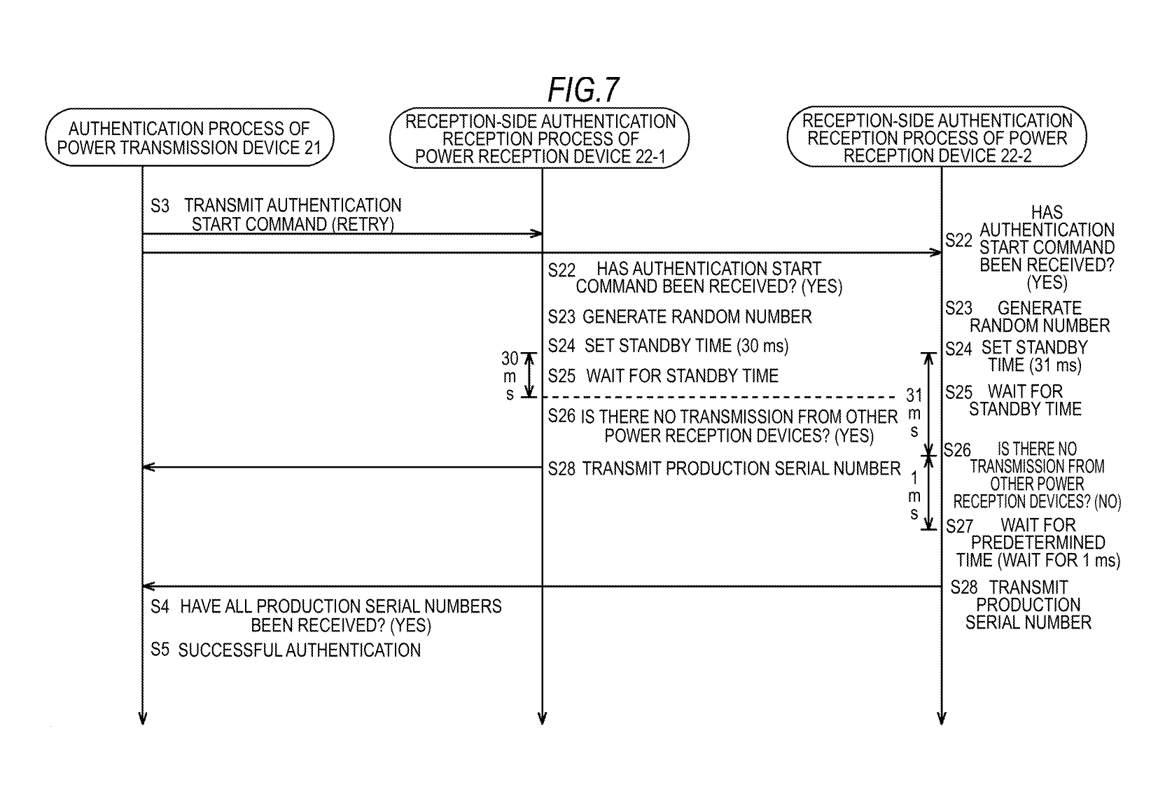

FIGS. 6 and 7 are flowcharts illustrating an example of the relationship of mutual processes of the power transmission device 21 and the power reception devices 22-1 and 22-2 (for the case where N=2).

### [Power Transmission-Side Authentication Process]

First, the power transmission-side authentication process performed by the power transmission device 21 will be described with reference to the flowchart illustrated in FIG. 4. The mutual processing relationship between the power transmission device 21 and the power reception device 22 can be easily understood by referring to a corresponding step of FIGS. 6 and 7.

In Step S1, the power transmission device 21 determines whether the switch 33 is in the ON state.

While the switch 33 is in the OFF state, “NO” is determined in Step S1, and the process is returned back to Step S1. Accordingly, processes thereafter are repeated. In other words, while the switch 33 is in the OFF state, the determination process of Step S1 is repeated.

Thereafter, when the state of the switch 33 transits from the OFF state to the ON state, “YES” is determined in Step S1, and the process proceeds to Step S2.

In Step S2, the power transmission device 21 starts to supply power to the power reception device 22.

In Step S3, the power transmission device 21 transmits an authentication start command to the power reception device 22.

The authentication start command is an example of an identification signal that is predetermined inside the power transmission device 21. In other words, the identification signal needs not to be the authentication start command as long as the identification signal is information that can be recognized as an authentication request by the power reception device 22.

Here, it is assumed that the production serial number of the power reception device 22, which is an authentication target, of the power reception devices 22-1 to 22-N is known to the power transmission device 21 in advance. In other words, in this example, in a case where a production serial number transmitted from the power reception device 21 coincides with an existing production serial number, the power transmission device 21 determines that the production serial number of the power reception device 21 is received and performs authentication of the power reception device 21.

In such a case, in Step S4, the power transmission device 21 determines whether all the production serial numbers of the authentication targets are received.

In a case where at least one production serial number out of the production serial numbers (existing production serial numbers) of the authentication targets has not been received, “NO” is determined in Step S4, and the process proceeds to Step S6.

In Step S6, the power transmission device 21 determines whether a predetermined time has elapsed.

When the predetermined time has not elapsed, “NO” is determined in Step S6. Thus, the process is returned back to Step S4, and processes thereafter are repeated. In other words, the predetermined time is set as a standby time until all the production serial numbers (existing numbers) of the authentication targets are received. In other words, the predetermined time is set as a standby time for an authentication request. The above-described predetermined time is not particularly limited. However, for example, it is preferable that the predetermined time is equal to or shorter than 100 ms in consideration of the predetermined time as the standby time for an authentication request.

Accordingly, until the predetermined time elapses, it is within the standby time for an authentication request. Thus, even when there is a production serial number out of the production serial numbers (existing production serial numbers) of the authentication targets that has not been received, the looping process of Steps S4 and S6 is repeated, thereby determination of the success or failure of authentication is awaited.

Thereafter, in a case where all the production serial numbers of the authentication targets are received until the predetermined time elapses, “YES” is determined in Step S4, and the process proceeds to Step S5. In Step S5, the power transmission device 21 recognizes a successful authentication. Accordingly, the power transmission-side authentication process is completed.

On the other hand, in a case where there is still a production serial number out of the production serial numbers (existing production serial numbers) of the authentication targets that has not been received, “YES” is determined in Step S6, and the process proceeds to Step S7.

In Step S7, the power transmission device 21 determines whether a predetermined error condition is satisfied. The error condition is not particularly limited. For example, here, a condition that the number (hereinafter, referred to as the number of retries) of repetitions of transmission of the authentication start command is equal to or greater than a defined number is employed.

In a case where the predetermined error condition is not satisfied, “NO” is determined in Step S7, and the process is returned back to Step S3. Then, processes thereafter are repeated. In other words, the authentication start command is transmitted again, and the determination of a success or failure of authentication is retried.

On the other hand, in a case where the predetermined error condition is satisfied, “YES” is determined in Step S7, and the process proceeds to Step S8. In Step S8, the power transmission device 21 recognizes a failed authentication. Accordingly, the power transmission-side authentication process is completed.

### [Power Reception-Side Authentication Reception Process]

Next, the power reception-side authentication reception process will be described with reference to the flowchart illustrated in FIG. 5. The mutual processing relationship between the power transmission device 21 and the power reception device 22 can be easily understood by referring to a corresponding step of FIGS. 6 and 7.

In Step S21, the power reception device 22 determines whether power is supplied from the power transmission device 21.

In a case where power is not supplied from the power transmission device 21, “NO” is determined in Step S21, and the process is returned back to Step S21. Then, processes thereafter are repeated. In other words, until the supply of power from the power transmission device 21 is started, the determination process of Step S21 is repeated.

Thereafter, in a case where the supply of power from the power transmission device 21 is started (in a case where the process of Step S2 illustrated in FIG. 4 is performed), “YES” is determined in Step S21, and the process proceeds to Step S22.

In Step S22, the power reception device 22 determines whether an authentication start command has been received from the power transmission device 21.

In Step S22, when the authentication start command is determined not to be received, the process is returned to Step S22, and it is determined again whether the authentication start command has been received. In other words, until the authentication start command is received from the power transmission device 21, the determination process of Step S22 is repeated.

Thereafter, in a case where the authentication start command is received from the power transmission device 21 (a case where the process of Step S3 illustrated in FIG. 4 is performed), “YES” is determined in Step S22, and the process proceeds to Step S23.

In Step S23, the power reception device 22 generates a random number.

In Step S24, the power reception device 22 sets a standby time corresponding to the random number.

In addition, the place in which the random number is generated or the place in which the standby time is set is not particularly limited. For example, in this embodiment, the microcomputer 44 generates a random number and sets a standby time corresponding to the random number.

In Step S25, the power reception device 22 waits for the standby time.

In Step S26, the power reception device 22 determines whether there is transmission from any other power reception device 22.

In a case where there is no transmission from any other power reception device 22, “YES” is determined in Step S26, and the process proceeds to Step S28. In Step S28, the power reception device 22 transmits the production serial number to the power transmission device 21.

On the other hand, in a case where there is transmission from any other reception device 22, “NO” is determined in Step S26, and the process proceeds to Step S27.

In Step S27, the power reception device 22 waits for a predetermined time. In other words, in the case where there is transmission from any other reception device 22, the power reception device 22 waits for a predetermined time without transmitting the production serial number. In other words, when the predetermined time elapses, the process proceeds to Step S28. In Step S28, the power reception device 22 transmits the production serial number to the power transmission device 21.

In Step S29, the power reception device 22 determines whether completion of the process is directed.

Unless completion of the process in directed, “NO” is determined in Step S29, and the process is returned back to Step S22. Then, processes thereafter are repeated. In other words, until the completion of the process is directed, the looping process of Steps S22 to S29 is repeated.

Thereafter, in a case where the completion of the process is directed, “YES” is determined in Step S29, and the power reception-side authentication reception process is completed.

[Processing Relationship between Power Transmission Device 21 and Power Reception Device 22]

Hereinafter, in the viewpoint of mutual processing of the power transmission device 21 and the power reception device 22, the power transmission-side authentication process and the power reception-side authentication reception process will be described with reference to FIGS. 6 and 7.

Here, for example, it is assumed that the power reception devices 22-1 and 22-2, represented by a set of speakers, one left and one right, respectively are authentication targets of the power transmission device 21.

In FIGS. 6 and 7, from the left side, a flowchart illustrating an example of the authentication process of the power transmission device 21, a flowchart illustrating an example of the authentication reception process of the power reception device 22-1, and a flowchart illustrating an example of the authentication reception process of the power reception device 22-2 are shown. In addition, arrows disposed between the flowcharts represent the flows of information.

When the switch 33 is in the ON state, “YES” is determined in the process of Step S1 illustrated in FIG. 6, and supply of power is started by the power transmission device in the process of Step S2.

Then, the power reception devices 22-1 and 22-2 determine that the power is supplied in Step S21.

Meanwhile, the power transmission device 21 transmits an authentication start command as the process of Step S3.

In such a case, when receiving the authentication start command, each of the power reception devices 22-1 and 22-2 determines “YES” in Step S22, and the process proceeds to Step S23.

In Step S23, each of the power reception devices 22-1 and 22-2 generates a random number.

In Step S24, each of the power reception devices 22-1 and 22-2 sets a standby time corresponding to the random number thereof. Here, for example, it is assumed that the standby times set in correspondence with the random numbers of the power reception devices 22-1 and 22-2 are the same as 30 ms.

In such a case, in Step S25, each of the power reception devices 22-1 and 22-2 waits for the standby time thereof. In other words, the power reception devices 22-1 and 22-2 wait for the same time of 30 ms.

In Step S26, each of the power reception devices 22-1 and 22-2 determines whether there is transmission from any other power reception device 22. In such a case, the standby times of the power reception devices 22-1 and 22-2 are the same, and transmission from any other power reception device 22 is not detected. Thus, “YES” is determined in Step S26, and the process proceeds to Step S28.

In Step S28, each of the power reception devices 22-1 and 22-2 transmits the production serial number thereof to the power transmission device 21. In other words, the production serial numbers of the power reception devices 22-1 and 22-2 are simultaneously transmitted to the power transmission device 21.

In such a case, the production serial numbers that are transmitted from the power reception devices 22-1 and 22-2 interfere with each other for the power transmission device 21. Accordingly, it is difficult for the power transmission device 21 to recognize any of the production serial numbers. Thus, the power transmission device 21 determines “NO” in the determination process on whether all the production serial numbers of the authentication targets have been received in Step S4, and the process proceeds to Step S6.

Even when a predetermined time elapses after the interference, the production serial number is not retransmitted from any of the power reception device 22-1 and the power reception device 22-2. Accordingly, “YES” is determined in Step S6, and the process proceeds to Step S7.

In Step S7, the power transmission device 21 determines whether the predetermined error condition is satisfied.

In such a case, in a case where the predetermined error condition is not satisfied, “NO” is determined in Step S7, and the process is returned back to Step S3 illustrated FIG. 7.

In other words, the power transmission device 21 retransmits an authentication start command as the process of Step S3 performed again. In other words, the power transmission device 21 retries the transmission of the authentication start command.

In such a case, when receiving the authentication start command, each of the power reception devices 22-1 and 22-2 determines “YES” in Step S22, and the process proceeds to Step S23.

In Step S23, each of the power reception devices 22-1 and 22-2 generates a random number.

In Step S24, each of the power reception devices 22-1 and 22-2 sets a standby time corresponding to the random number thereof. Here, for example, it is assumed that the standby time set in correspondence with the random number of the power reception device 22-1 is 30 ms. On the other hand, it is assumed that the standby time set in correspondence with the random number of the power reception device 22-2 is 31 ms.

In Step S25, the power reception devices 22-1 and 22-2 wait for the standby times thereof.

In other words, at a time point when 30 ms elapses from the start time point of the process of Step S25, the process of the power reception device 22-1 proceeds to Step S26, and the power reception device 22-2 still waits (the process of Step S25 is performed).

Accordingly, the power reception device 22-1 determines that there is no transmission from any other power reception device 22 in Step S26 and transmits the production serial number in Step S28.

Here, for example, it is assumed that a time interval of 2 ms may be needed for completion of transmission of the production serial number. In other words, at a time point when 31 ms elapses from the start time point of the process of Step S25, the power reception device 22-1 is in the middle of transmission of the production serial number (in the middle of the process of Step S28), and the process of the power reception device 22-2 proceeds to Step S26.

As described above, at the time point when the process of Step S26 of the power reception device 22-2 is started, the power reception device 22-1 is in the middle of transmission of the production serial number. Accordingly, “NO” is determined in Step S26, and the process proceeds to Step S27.

In Step S27, the power reception device 22-2 waits for a predetermined time. Here, when it is known that a time interval of 2 ms may be needed for completion of transmission of the production serial number, an arbitrary time equal to or longer than 1 ms may be set as the predetermined time. For example, here, it is assumed that 1 ms is set as the predetermined time. In such a case, when 1 ms elapses from the time point when the process of Step S27 is started, that is, at a time point when 32 ms elapses from the time point when the process of Step S25 is started, the process proceeds to Step S28 in the power reception device 22-2. In addition, at this time point, the power reception device 22-1 completes the transmission of the production serial number. In Step S28, the power reception device 22-2 transmits the production serial number.

In other words, when the time point when the process of Step S25 is started is set as reference time, in the viewpoint of the power transmission device 21, the production serial number of the power reception device 22-1 is received between 30 ms to 32 ms from the reference time. Next, the production serial number of the power reception device 22-2 is received between 32 ms to 34 ms from the reference time.

In other words, interference between the production serial numbers does not occur in the power transmission device 21. Accordingly, all the production serial numbers of the authentication targets are determined to be received in Step S4, and the process proceeds to Step S5. In Step S5, the power transmission device 21 recognizes a successful authentication, and the power transmission-side authentication process is completed.

Accordingly, the power transmission device 21 can recognize the power reception devices 22-1 and 22-2 that are configured by two wireless speakers, one left and one right speaker, forming one set. Thus, the power transmission device 21, thereafter, can start normal device operations of the power reception devices 22-1 and 22-2. In particular, for example, when one of the normal device operations is speech output, right after the successful authentication is recognized in Step S5, output of speech is started from the left and right wireless speakers (the power reception devices 22-1 and 22-2).

As described above, in the mutual processing of the power transmission device 21 and the power reception device 22, the power reception device 22 can generate a random number and sets a standby time corresponding to the random number. As a result, a difference in transmission time of the production serial numbers of a plurality of the power reception devices 22 can be arranged (see Steps S23 to S25 and S28 shown in FIG. 5). Accordingly, the possibility that the production serial numbers transmitted from the plurality of the power reception devices 22 to the power transmission device 21 interferes with one another is much lowered.

In addition, even when the interference occurs on the power transmission device 22 side, the interference can be avoided by retrying the transmission of the production serial number (see FIG. 6).

Furthermore, when the random numbers generated by the power reception devices 22 are close to one another, and the difference in transmission time is small, the power reception device 22 can transmit the production serial number after the completion of transmission of other power reception devices 22 by intercepting transmission signals (see FIG. 7).

In addition, in the above-described example, the production serial number is used for authentication. However, the embodiment is not limited thereto. Thus, for performing the power transmission-side authentication process and the power reception-side authentication reception process, any unique identification number of the power reception device 22 may be used. In other words, the production serial number is only an example of a unique identification number of the power reception device 22.

As another example, in order to improve security, an identifier acquired by combining a production serial number and a product type name, which is unique information other than the production serial number, may be used as a unique identification number of the power reception device 22. In addition, for example, in a case where the power reception devices 22 are network devices, MAC addresses thereof may be used as the unique identification numbers of the power reception devices 22. Furthermore, for example, an arbitrary symbol string such as a unique number or a character line may be used as the unique identification number of the power reception device 22 as long as the symbol string can be indentified from those of other power reception devices 22. Either way, a unique identification number of any format, such as a unique identification number of a format that is a unique value out of 000000 to 999999, for example, may be used as production serial numbers which can be recognized on the power transmission device 21 side.

In addition, as the setting information for setting the standby time, a random number is used in the above-described example. However, the setting information is not particularly limited to a random number. Thus, any information used for arranging a difference in transmission time of unique identification numbers (the production serial numbers or the like) of a plurality of the power reception devices 22 may be used. For example, a unique identification number (the production serial number or the like) maybe used as the setting information. In addition, for example, a unique number that is preset for each power reception device 22, in particular, a unique number such as 10 ms or 50 ms maybe used as the setting information.

### <3. Second Example of Authentication Operation of Information Processing System>

The above-described first example of the authentication operation of the information processing system described with reference to FIGS. 4 to 7 is an example in which all the production serial numbers as an example of the unique identification numbers of the power reception devices 22 are authenticated on the power transmission device 21 side.

However, depending on the type of the power transmission device 21, there are cases where all the plurality of power reception devices 22 may not need to be authenticated. For example, in a case where the power reception devices 22 are configured by cellular phones, and the power transmission device 21 is a charging device for the cellular phones, when there are a plurality of cellular phones nearby, and at least one of the plurality of the cellular phones may need to be charged, it is preferable that the power transmission device 21 recognizes a successful authentication so as to start a charging operation.

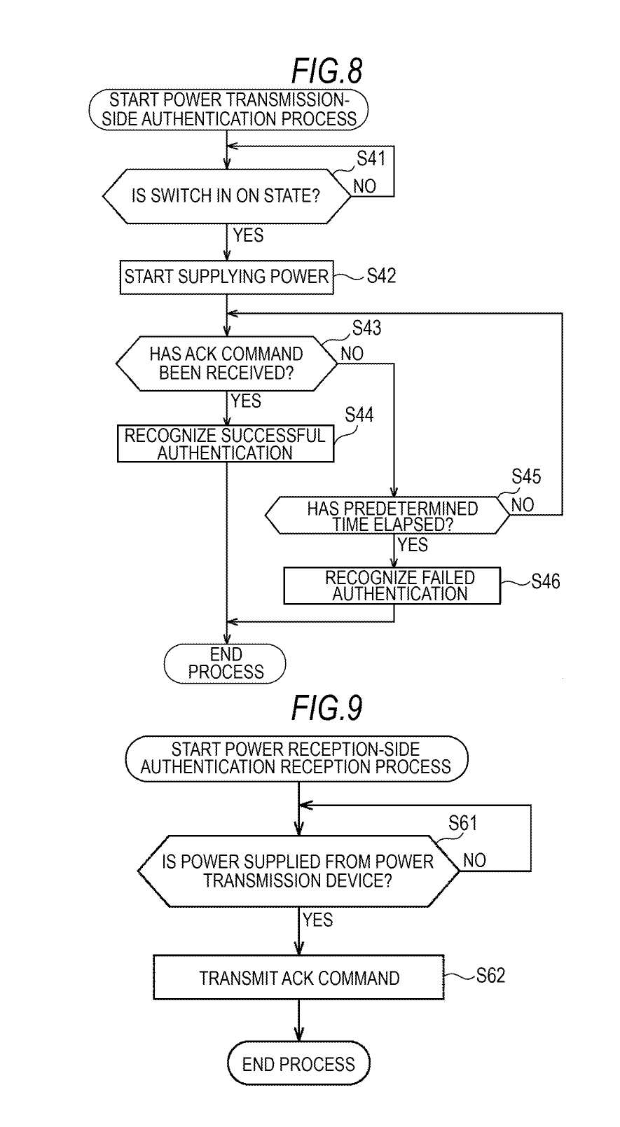

In such a case, a process in which the power transmission device 21 recognizes a successful authentication by returning the same ACK (acknowledgement) command from the plurality of power reception devices 22 may be used as the power transmission-side authentication process. In other words, as the power reception-side authentication reception process, a process in which an ACK command, which is the same as those of other power reception devices 22, is returned to the power transmission device 21 may be employed. In such a case, the power transmission device 21 and the power reception devices 22 can be implemented by devices having a relatively simple configuration. Hereinafter, the power transmission-side authentication process and the power reception-side authentication reception process described above will be sequentially described with reference to FIGS. 8 and 9.

### [Power Transmission-Side Authentication Process]

FIG. 8 is an example of the power transmission-side authentication process and is a flowchart illustrating an example other than that illustrated in FIG. 4.

The processes of Steps S41 and S42 shown in FIG. 8 are the same as those of Steps S1 and S2 shown in FIG. 4. Thus, here, the description thereof is omitted.

In Step S43, the power transmission device 21 determines whether an ACK command has been received.

In a case where an ACK command is determined not to be received in Step S43, the process proceeds to Step S45.

In Step S45, the power transmission device 21 determines whether a predetermined time has elapsed.

In a case where the predetermined time has not elapsed, “NO” is determined in Step S45. Thus, the process is returned to Step S43, and processes thereafter are repeated. In other words, as a standby time until an ACK command is received, the predetermined time is set. Accordingly, until the predetermined time elapses, even in a case where one ACK command has not been received, the looping process of Steps S43 and S45 is repeated. Therefore, the determination of a successful or failed authentication is awaited.

Thereafter, until the predetermined time elapses, in a case where an ACK command is received from at least one of the plurality of power reception devices 22, “YES” is determined in Step S43, and the process proceeds to Step S44. In Step S44, the power transmission device 21 recognizes a successful authentication. Accordingly, the power transmission-side authentication process is completed.

On the other hand, in a case where any ACK command has not been received from any of the plurality of the power reception devices 22 when the predetermined time elapses, “YES” is determined in Step S45, and the process proceeds to Step S46. In Step S46, the power transmission device 21 recognizes a failed authentication. Accordingly, the power transmission-side authentication process is completed.

### [Power Reception-Side Authentication Reception Process]

Next, the power reception-side authentication reception process will be described with reference to the flowchart illustrated in FIG. 9.

FIG. 9 is an example of the power reception-side authentication reception process and is a flowchart illustrating an example (an example corresponding to FIG. 8) other than that illustrated in FIG. 5.

In Step S61, the power reception device 22 determines whether power is supplied from the power transmission device 21.

In a case where power is not supplied from the power transmission device 21, “NO” is determined in Step S61, and the process is returned back to Step S61. Then, processes thereafter are repeated. In other words, until the supply of power from the power transmission device 21 is started, the determination process of Step S61 is repeated.

Thereafter, in a case where the supply of power from the power transmission device 21 is started (in a case where the process of Step S42 illustrated in FIG. 8 is performed), “YES” is determined in Step S61, and the process proceeds to Step S62.

In Step S62, the power reception device 22 transmits an ACK command to the power transmission device 21. In other words, in this embodiment, the supply of power from the power transmission device 21 is treated as an authentication request transmitted from the power transmission device 21. In other words, the authentication request from the power transmission device 21 is not particularly limited to the supply of power of this example. Thus, as the authentication request, any form that can be recognized as an authentication request by the power reception device 22 may be used.

When the ACK command is transmitted from the power reception device 22, the power reception-side authentication reception process is completed. Then, in the power transmission-side authentication process, “YES” is determined in the process of Step S43 shown in FIG. 8. Accordingly, a successful authentication is recognized in the process of Step S44.

All the ACK commands of the plurality of the power reception devices 22 are the same. However, the ACK commands are transmitted approximately simultaneously with conduction (approximately simultaneously with the determination of “YES” in Step S61 shown in FIG. 9). In other words, the transmission times of the ACK commands of the plurality of the power reception devices 22 are almost the same. As a result, the possibility of interference on the power transmission device 21 side is lowered. In addition, accordingly, as described above, the power transmission device 21 and the power reception devices 22 can be implemented so as to have relatively simple configurations.

In this case, the time for the power transmission-side authentication process was a short time of about 100 ms as a result of measurement even in a case where there were, for example, up to ten power reception devices 22. Accordingly, even in a case where there is no authentication target, negative influence on other power reception devices 22 can be substantially ignored.

### <4. Other Applications of Embodiments of Present Invention>

As an information processing system according to an embodiment of the present invention, the power transmission systems having the configurations shown in FIGS. 1 to 3 have been described as examples. However, an embodiment of the present invention is not particularly limited to the above-described example. Thus, an embodiment of the present invention may be in the form of any information processing system in which information is transmitted and received between an authentication device and a plurality of authentication reception devices.

For example, in the above-described examples, as a technique for transmission and reception of information between the power transmission side and the power reception side, a technique utilizing electric waves is used. However, the transmission/reception technique is not particularly limited. Thus, other than the above-described technique, for example, a technique utilizing infrared rays or the like may used. In other words, as an embodiment of the present invention, an information processing system to which an arbitrary transmission/reception technique is applied may be used.

In addition, for example, as an embodiment of the present invention, an information processing system that is configured as a common one-to-N network device may be employed. In such a case, N does not need to be equal to or greater than two and may be one.

Furthermore, the series of processes described above may be performed by hardware or software. In a case where the series of processes is performed by software, a program configuring the software is installed from a program recording medium. This program, for example, is installed to a computer that is built in dedicated hardware. Alternatively, this program may be installed, for example, on a general-purpose personal computer or the like capable of performing various functions by installing various programs thereto.

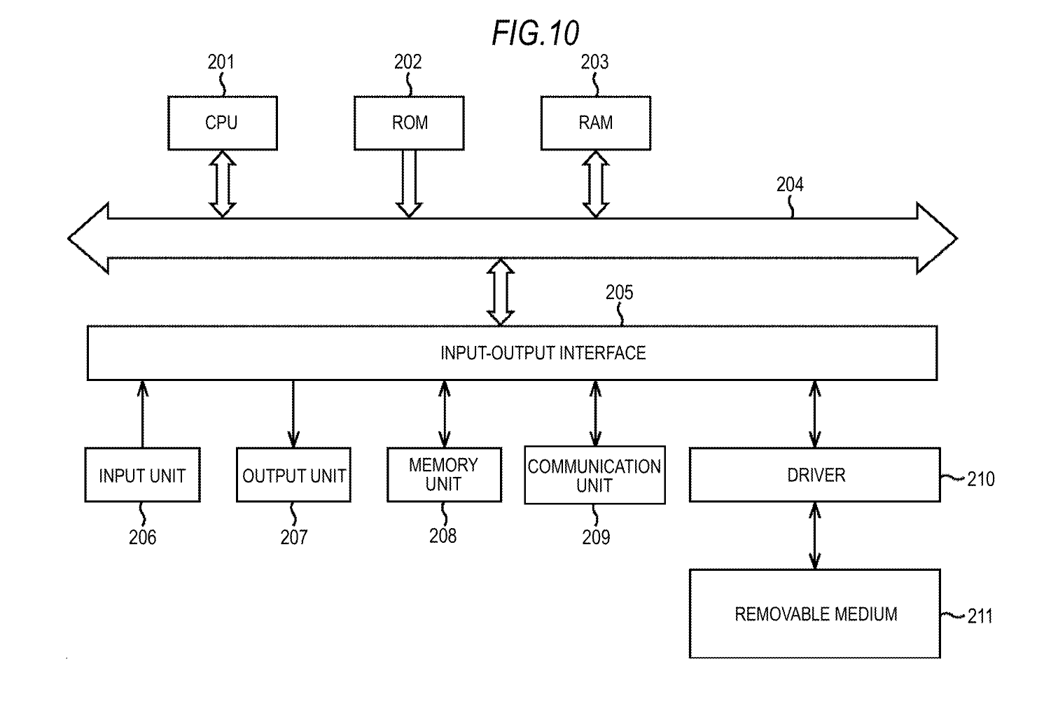

FIG. 10 is a block diagram representing a configuration example of the hardware of a computer that performs the series of processes described above in accordance with a program.

In the computer, a CPU 201, a ROM (Read Only Memory) 202, and a RAM (Random Access Memory) 203 are interconnected through a bus 204. In addition, an input-output interface 205 is connected to the bus 204. To the input-output interface 205, an input unit 206 that is configured by a keyboard, a mouse, a microphone or the like, an output unit 207 that is configured by a display, a speaker, or the like, and a memory unit 208 that is configured by a hard disk, a non-volatile memory, or the like are connected. In addition, to the input-output interface 205, a communication unit 209 that is configured by a network interface or the like and a drive 210 that drives a removable medium 211 such as a magnetic disk, an optical disc, a magneto-optical disc, or a semiconductor memory are connected.

In the computer configured as described above, the series of processes described above is performed as the CPU 201, for example, loads a program stored in the memory unit 208 into the RAM 203 through the input-output interface 205 and the bus 204 and executes the loaded program. The program executed by the computer (CPU 201), for example, is provided by being recorded on the removable medium 211 that is a magnetic disk (including a flexible disk). The program is provided by being recorded on the removable medium 211 that is a package medium. As the package medium, an optical disc (a CD-ROM (Compact Disc-Read Only Memory), a DVD (Digital Versatile Disc), or the like), a magneto-optical disc, a semiconductor memory, or the like is used. Alternatively, the program may be provided through a wired or wireless transmission medium such as a local area network, the Internet, or a digital satellite broadcast. The program can be installed in the memory unit 208 through the input-output interface 205 by loading the removable medium 211 into the drive 210. In addition, the program may be received by the communication unit 209 through the wired or wireless transmission medium and be installed in the memory unit 208. Alternatively, the program may be installed into the ROM 202 or the memory unit 208 in advance.

In addition, the program that is executed by the computer may be a program for performing processes in a time series in accordance with the sequence descried here, a program that performs the processes in parallel, or a program that performs a process at a necessary timing such as a timing when the program is called.

The embodiments of the present invention are not limited to the above-described embodiments and may be changed in various forms within the scope not departing from the basic concept of the present invention.

The present application contains subject matter related to that disclosed in Japanese Priority Patent Application JP 2009-097662 filed in the Japan Patent Office on Apr. 14, 2009, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device comprising:
a setting means for setting a standby time independently from another information processing device as an authentication target in a case where an authentication request is made from an authentication request-side device; and
a transmission means for waiting for the standby time set by the setting means and transmitting unique identification information to the authentication request-side device.

2. The information processing device according to claim 1, wherein the setting means generates a random number in a case where the authentication request is made and sets the standby time in correspondence with the random number.

3. The information processing device according to claim 1, wherein the authentication request is an identification signal that is set by the authentication request-side device in advance.

4. The information processing device according to claim 1, wherein the transmission means stops the transmitting of the unique identification information when recognizing transmission from another information processing device as the authentication target.

5. The information processing device according to claim 1, further comprising:
a power reception means for receiving power transmitted from a power transmission device,
wherein the authentication request-side device is configured by the power transmission device that transmits the power by using a magnetic resonance-type power transmission technique.

6. The information processing device according to claim 5, wherein the power transmission device starts the transmitting of the power before the authentication request.

7. An information processing method comprising the step of:
setting a standby time independently from another information processing device as an authentication target in a case where an authentication request is made from an authentication request-side device, waiting for the set standby time, and transmitting unique identification information to the authentication request-side device by using the information processing device that becomes an authentication target of the authentication request-side device.

8. An information processing system comprising:
an authentication request-side device; and
one or more information processing devices that become authentication targets,
wherein the authentication request-side device makes an authentication request for each of the one or more information processing devices,
wherein each of the one or more information processing devices sets a standby time independently from the other information processing devices as authentication targets, waits for the set standby time, and transmits unique identification information to the authentication request-side device in a case where the authentication request is made, and
wherein the authentication request-side device performs authentication of each of the one or more information processing devices by receiving the unique identification information transmitted from each of the one or more information processing devices.

9. An information processing device comprising:
a transmission means for transmitting identification information that is the same as that of another information processing device as an authentication target to an authentication request-side device in a case where an authentication request is made from the authentication request-side device.

10. An information processing method comprising the step of:
transmitting identification information that is the same as that of another information processing device as an authentication target to an authentication request-side device by using an information processing device that becomes an authentication target of the authentication request-side device in a case where an authentication request is made from the authentication request-side device.

11. An information processing system comprising:
an authentication request-side device; and
one or more information processing devices that become authentication targets,
wherein the authentication request-side device makes an authentication request for each of the one or more information processing devices,
wherein each of the one or more information processing devices transmits identification information that is the same as those of the other information processing devices as authentication targets to the authentication request-side device in a case where the authentication request is made, and
wherein the authentication request-side device performs authentication by receiving the identification information transmitted from at least one of the one or more information processing devices.

12. An information processing device comprising:
a setting unit configured to set a standby time independently from another information processing device as an authentication target in a case where an authentication request is made from an authentication request-side device; and
a transmission unit configured to wait for the standby time set by the setting unit and transmit unique identification information to the authentication request-side device.
